(19) United States
(12) Patent Application Publication
(10) Pub. No.: US 2016/0335916 A1
(43) Pub. Date: Nov. 17, 2016

(54) PORTABLE DEVICE AND CONTROL METHOD USING PLURALITY OF CAMERAS

(71) Applicant: SAMSUNG ELECTRONICS CO., LTD, Suwon-si, Gyeonggi-do (KR)

(72) Inventors: Jongwoo LEE, Seoul (KR); Hyejin MOON, Seongnam-si (KR); Heeyong SONG, Seoul (KR)

(21) Appl. No.: 15/112,833

(22) PCT Filed: Jan. 20, 2015
(86) PCT No.: PCT/KR2015/000587

§ 371 Date: Jul. 20, 2016

(30) Foreign Application Priority Data
Jan. 20, 2014 (KR) 10-2014-0006939

(51) Int. Cl. G09B 21/00; H04W 4/02; G06K 9/00; H04N 5/247; G06F 3/16; G06T 7/00

(52) U.S. Cl. CPC G09B 21/006; G06F 3/16; G06T 7/0044; G06K 9/00671; G06K 9/00288; H04N 5/247; H04W 4/023

(57) ABSTRACT

A method for controlling a terminal including a camera according to an embodiment of the present specification comprises the steps of: receiving an image through the camera; determining at least one object from the received image; calculating the distance between the object and the terminal on the basis of information related to the determined object; and outputting a signal determined on the basis of the distance between the calculated object and the terminal. According to an embodiment of the present specification, information between the terminal and a neighboring object can be determined on the basis of image information which a plurality of visual input devices has received, and an auditory output can be provided on the basis of the determined information. Further, the method has identification methods and identifiable distances different according to a distance from a neighboring object, and thus can provide information on neighboring objects different according to a motion pattern of a user.

### TECHNICAL FIELD

Various embodiments of the present disclosure relate to a wearable device including a plurality of cameras and a method using the same and, more particularly, to a device and a method for providing information for a user by calculating a distance of an object obtained from a plurality of cameras and analyzing the calculated object.

### BACKGROUND ART

As electronic devices become miniaturized, various devices can provide information for a user by detecting a visual input so that the user can identify an object located nearby a portable device. In particular, various devices for blind persons detect a neighboring object through a camera and provide information for the blind persons. “Voice Over” and “Accessibility” functions are provided to help blind persons use smartphones; however, much training and effort are required to use a smartphone in daily life, and there are insufficient contents provided for blind persons. Further, blind persons may feel inconvenience in their activities while using a smartphone. Conventional devices provide location information for a user on the basis of a database; however, the accuracy of the module for detecting a user's location such as a GPS and database is insufficient. Therefore, correct information cannot be provided for a user if the user has a low visual discriminatory capability like a blind person.

### DISCLOSURE OF INVENTION

### Technical Problem

Various embodiments of the present disclosure are suggested to solve the above problems, and an object of the present disclosure is to provide a portable terminal having a plurality of cameras and a method using the same. Further, another object of the present disclosure is to provide a method and a device that can notify a user with information related to a neighboring object identified by a visual input device of a portable terminal through an audio output.

### Solution to Problem

In order to achieve the above object, a method for controlling a terminal according to an embodiment of the present specification includes the steps of receiving an image through the camera, identifying at least one object from the received image, calculating a distance between the object and the terminal on the basis of information related to the determined object, and outputting a signal determined on the basis of the distance between the calculated object and the terminal.

A terminal for receiving an image input according to another embodiment of the present disclosure includes a camera unit configured to receive an image input and a control unit configured to control the camera unit, to receive an image from the camera unit, to determine at least one object from the received image, to calculate a distance between the object and the terminal on the basis of information related to the determined object, and to output a signal determined on the basis of the distance between the calculated object and the terminal.

### Advantageous Effects of Invention

According to various embodiments of the present disclosure, information between a terminal and neighboring object can be identified on the basis of image information received from a plurality of visual input devices, and an auditory output can be provided accordingly. Further, information of different neighboring objects can be provided according to a user's operation pattern by using different recognition methods according to the distance from neighboring objects located at an identifiable distance.

### BRIEF DESCRIPTION OF DRAWINGS

FIG. 1 is a schematic drawing illustrating a terminal according to an embodiment of the present disclosure.

FIG. 2 is a flowchart illustrating a method for operating a terminal according to an embodiment of the present disclosure.

FIG. 3 is a schematic drawing illustrating a method for operating a terminal according to an embodiment of the present disclosure.

FIG. 4 is a schematic drawing illustrating another method for identifying a distance of an object in a terminal according to an embodiment of the present disclosure.

FIG. 5 is a flowchart illustrating a method for transmitting and receiving a signal between components of a terminal according to an embodiment of the present disclosure.

FIG. 6 is a flowchart illustrating a method for identifying a user's location information and outputting related information in a terminal according to an embodiment of the present disclosure.

FIG. 7 is a flowchart illustrating a method for recognizing a face and providing related information according to an embodiment of the present disclosure.

FIG. 8 is a flowchart illustrating a method for setting a mode of a terminal according to an embodiment of the present disclosure.

FIG. 9 is a block diagram illustrating components included in a terminal according to an embodiment of the present disclosure.

FIG. 10 is a schematic drawing illustrating components of a terminal according to another embodiment of the present disclosure.

### MODE FOR THE INVENTION

Hereinafter, embodiments of the present disclosure are described in detail with reference to the accompanying drawings. The same reference symbols are used throughout the drawings to refer to the same or like parts. Detailed descriptions of well-known functions and structures incorporated herein may be omitted to avoid obscuring the subject matter of the disclosure.

For the same reasons, some components in the accompanying drawings are emphasized, omitted, or schematically illustrated, and the size of each component does not fully reflect the actual size. Therefore, the present invention is not limited to the relative sizes and distances illustrated in the accompanying drawings.

The following description with reference to the accompanying drawings is provided to assist in a comprehensive understanding of various embodiments of the present disclosure as defined by the claims and their equivalents. It includes various specific details to assist in that understanding, but they are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

Here, it should be understood that each block and combinations of flowcharts can be performed by computer program instructions. The computer program instructions can be loaded into a general-purpose computer, special computer, or a programmable data processing equipment, and the instructions performed by the computer or the programmable data processing equipment generates means for performing functions described in each block of the flowcharts. The computer program instructions can be stored in a computer-available or computer-readable memory so that the computer or programmable data processing equipment can perform a function in a specific method; thus, the instructions stored in the computer-available or computer-readable memory can include instruction means for performing a function described in each block of the flowchart. Because the computer program instructions can be loaded into a computer or programmable data processing equipment, the computer or programmable data processing equipment can generate a process for performing a series of operations in order to execute functions described in each block of the flowchart.

Further, each block may indicate a portion of a module, segment, or code including at least one executable instruction for performing a specific logical function. It should be understood that the functions described in the blocks may be performed in different sequences in various embodiments. For example, two adjacent blocks may be performed simultaneously or sometimes in inverse order according to a corresponding function.

Here, a term “unit” used in the embodiments of the present disclosure means software or hardware components such as a FPGA or ASIC and performs a specific role. However, the “unit” is not limited to a software or hardware component, and it may be configured to be located in an addressable storage medium or to play at least one processor. For example, the “unit” may include software components, object-oriented software components, class components, and task components, such as processes, functions, attributes, procedures, subroutines, segments of program code, drivers, firmware, microcode, circuits, data, databases, data structures, tales, arrays, and variables. Functions provided by the components and “units” can be combined with a smaller number of components and “units” or divided into additional components and “units”. Further, the components and “units” can be configured to play at least one CPU in a device or a security multimedia card.

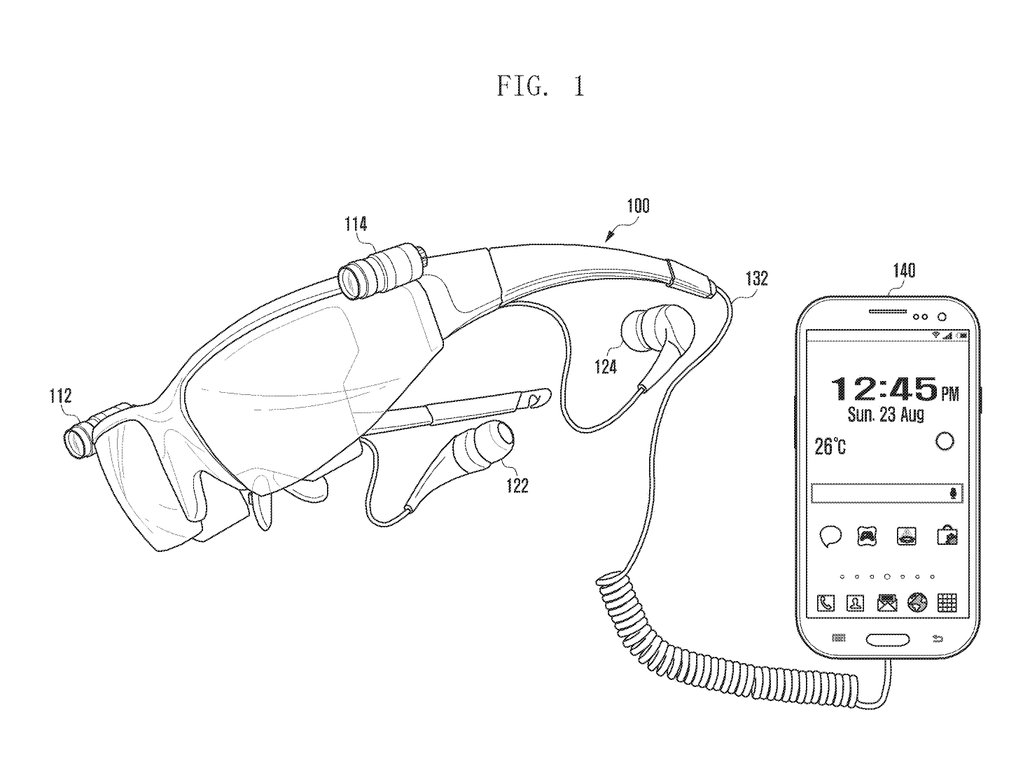

FIG. 1 is a schematic drawing illustrating a terminal according to an embodiment of the present disclosure.

Referring to FIG. 1, the terminal according to an embodiment of the present disclosure may include a frame unit 100, plurality of camera units 112 and 114, audio output units 122 and 124, and an interface unit 132.

The frame unit 100 enables a user to wear the terminal and may have a shape similar to eyeglasses.

The camera units 112 and 114 are attached to the frame unit 100, receive a visual input in a direction corresponding to the user's sight, and calculate a distance by using a phase difference of an object displaced a predetermined distance on the basis of the direction corresponding to the user's sight. Further, a separate camera unit can be included in a part not shown in the drawing, and the activities of a user's eyeball can be detected by the separate camera unit. According to an embodiment of the present disclosure, an additional camera unit may be further installed in the direction of the user's sight.

The audio output units 122 and 124 may be attached to the frame unit 100 or connected through an extension cable. In the embodiment, the audio units 122 and 124 may be formed in an earphone shape or a different shape which can transmit an audio output effectively. The audio output units 122 and 124 can transmit information related to operations of the terminal to the user through the audio output. In more detail, the audio output units 122 and 124 can output information generated by at least one of character recognition, face recognition, and neighboring object information through the audio output by analyzing a visual input received from the camera units 112 and 114.

The interface unit 132 can connect the terminal with an external device 140 and can perform at least one of control signal reception or power supply. In the embodiment, the external device 140 may be configured with a mobile terminal such as a smartphone and can exchange a signal with the terminal through separate software. Further, the interface unit 132 can exchange a control signal with a separate terminal not only through a wired connection but also through a wireless connection.

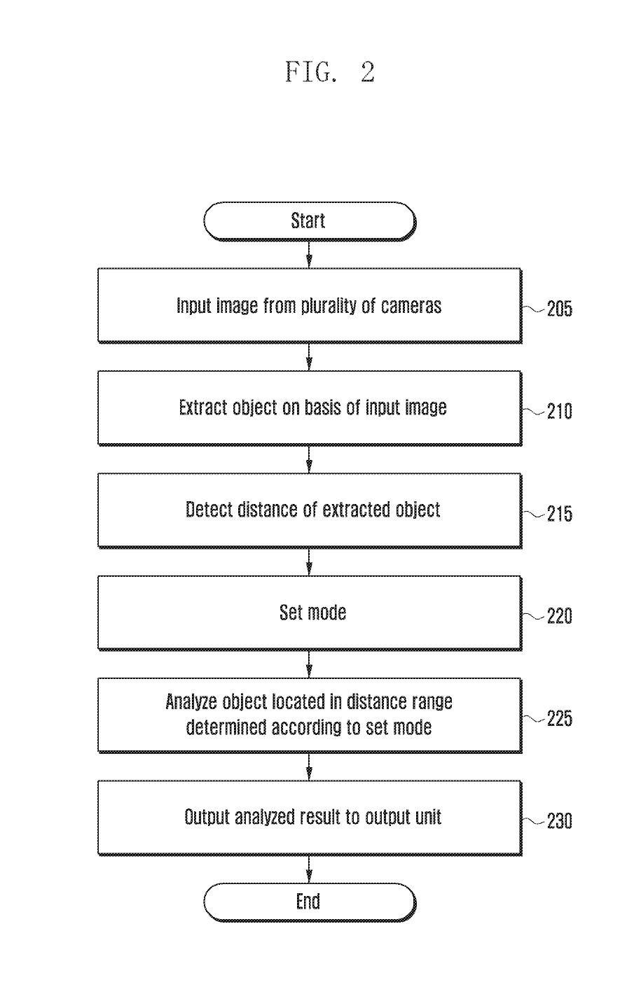

FIG. 2 is a flowchart illustrating a method for operating a terminal according to an embodiment of the present disclosure.

Referring to FIG. 2, the terminal receives image inputs from a plurality of cameras at Step 205. The plurality of cameras may be located by displacing a predetermined distance from each other in a direction corresponding to a user's sight. The plurality of cameras can operate under the control of a control unit and receive images periodically according to a time interval determined on the basis of time or a user's movement.

The terminal extracts an object from the input image at Step 210. In more detail, a portion having a rapid change in the image can be extracted as an object through a separate processing operation.

The terminal detects a distance of the extracted object at Step 215. In more detail, identical objects are identified from a plurality of objects in a plurality of images, and the distance to the object can be detected according to a phase difference value calculated from the identical objects in the plurality of images.

The terminal receives a mode setting from a user at Step 220. According to an embodiment of the present disclosure, the mode setting can be performed at any step before Step 220. According to the mode setting, the user can determine at least one of a distance range of an object to be analyzed, method of analyzing the object, and output method. The mode setting can be performed by a separate user input or according to a detection result of a sensor unit of the terminal corresponding to a user's movement.

The terminal analyzes the extracted object according to the mode setting at Step 225. In more detail, an object located in a distance range corresponding to a specific mode can be analyzed. According to an embodiment of the present disclosure, the analysis of an object may include at least one of character recognition, face recognition, and distance recognition.

The terminal outputs the result of analyzing the object through an output unit at Step 230. In more detail, the terminal can output the object analysis result through an audio output unit. The output result may include at least one of character recognition, face recognition, and distance recognition according to the object analysis result.

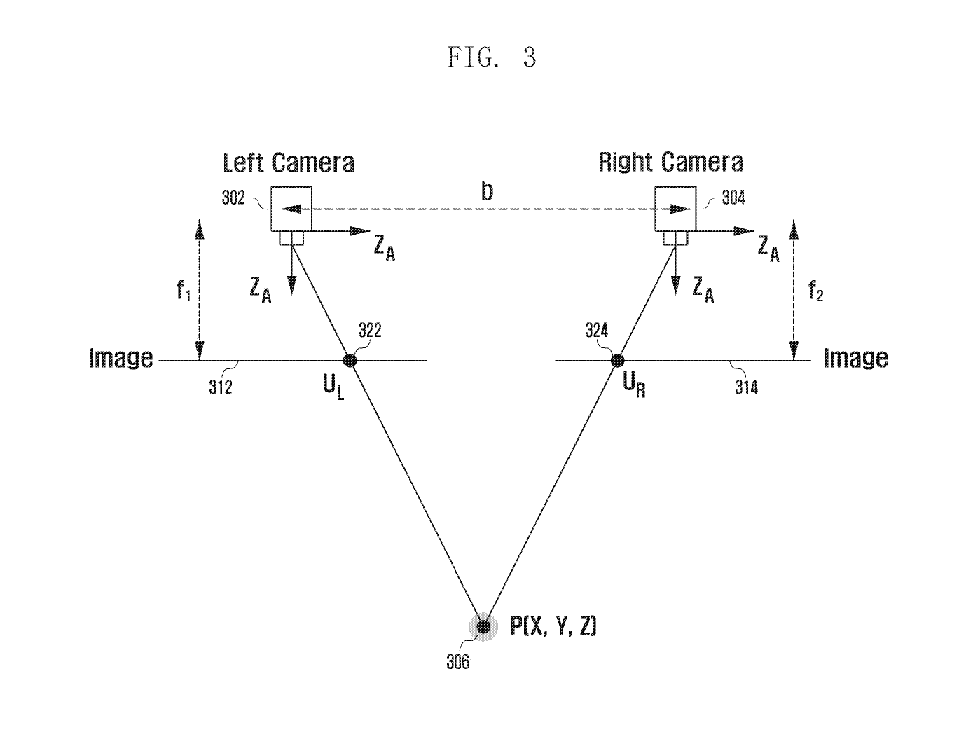

FIG. 3 is a schematic drawing illustrating a method for operating a terminal according to an embodiment of the present disclosure.

Referring to FIG. 3, the terminal according to an embodiment of the present disclosure may include a left camera 302 and a right camera 304. The plurality of cameras can detect a distance to an object 306. In a left image 312 formed by the left camera 302 and a right image 314 formed by the right camera 304, an object 306 can be indicated as a reference number 322 and a reference number 324. Here, the distance (depth) to the object 306 may be indicated by the following formula.

Depth=fSb/(U_{L}−U_{R}) Formula 1

In this embodiment, focal lengths f₁ and f₂ of images formed in each camera are identical, b indicates a distance between each camera unit, and (U_{L}−U_{R}) indicates a difference of distance between formed images. By using this method, the distance to an object can be calculated from the formed images.

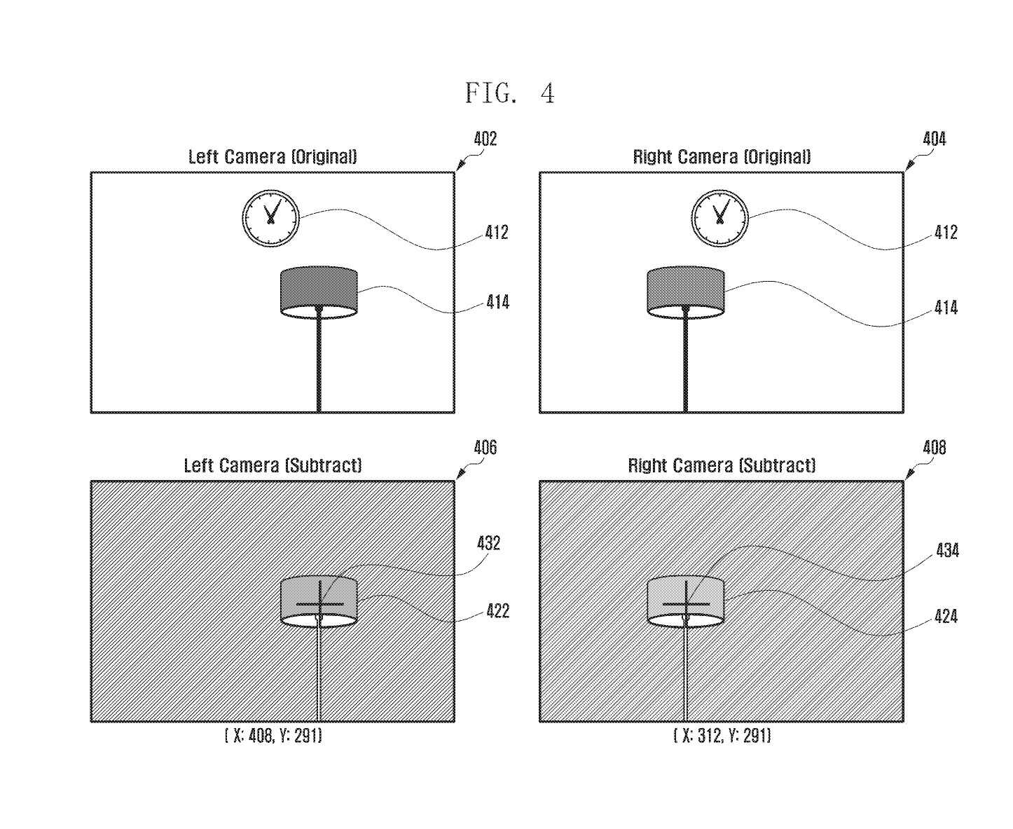

FIG. 4 is a schematic drawing illustrating another method for identifying a distance of an object in a terminal according to an embodiment of the present disclosure.

Referring to FIG. 4, a first image 402 input by a left camera and a second image 404 input by a right camera are shown in the drawing, and a first object 412 and a second object 414 are located in each image.

If duplicated objects are removed from the plurality of objects in each image to identify a distance to a second object as shown by reference numbers 406 and 408, the second object may be located as shown by reference numbers 422 and 424. The terminal can calculate center points 432 and 434 in a direction which each object is located at the right and left sides of the camera. Because each camera is located horizontally in this embodiment, the center points 432 and 434 can be calculated in the horizontal direction of the images and a distance between the center points of two images can be identified. If the identification is performed on the basis of the X-coordinate, the distance becomes 96 (408−312=96). Because the distances between the cameras and the focal length of the terminal have fixed values, the distance to an object 414 can be calculated from the fixed values. In case of first object 412, the difference of distance between two images is smaller than that of the second object 414; thus, the first object 412 can be identified to be located further than the second object 414, and the distance to the first object 412 can be calculated by calculating a distance between the two images on the basis of the center point of the first object 412 and by using the focal length and the distance between the two cameras.

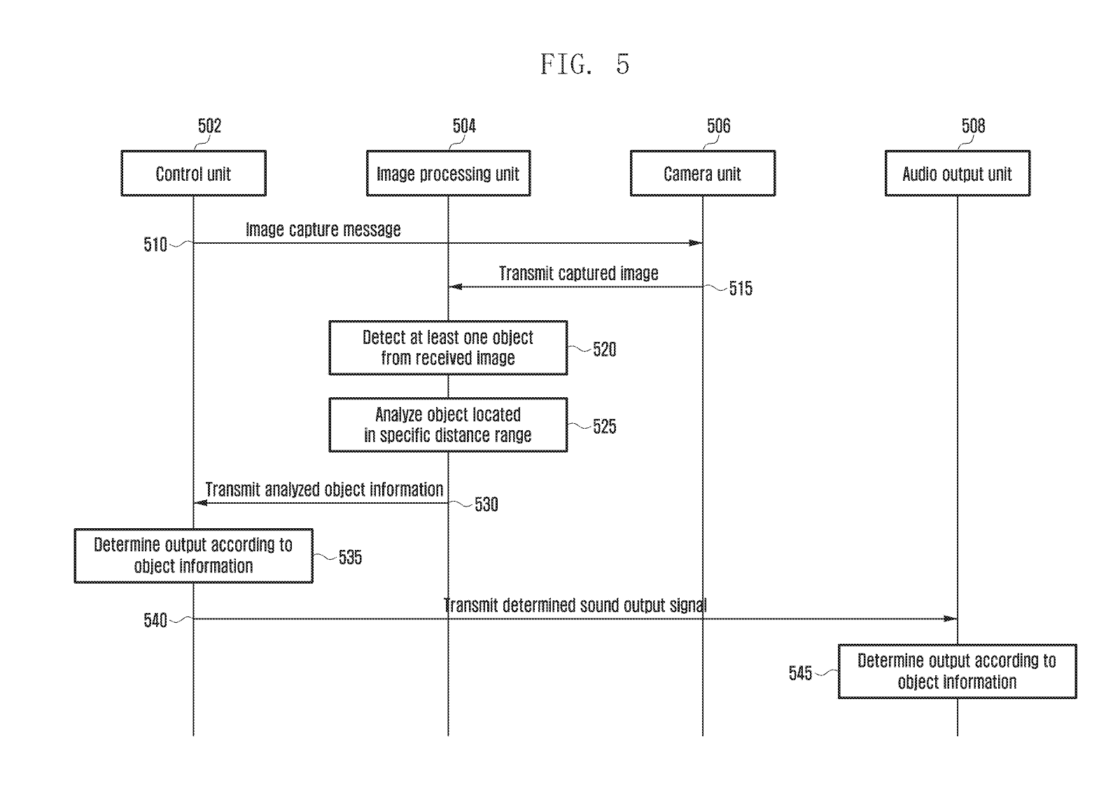

FIG. 5 is a flowchart illustrating a method for transmitting and receiving a signal between components of a terminal according to an embodiment of the present disclosure.

Referring to FIG. 5, the terminal according to an embodiment of the present disclosure may include a control unit 502, image processing unit 504, camera unit 506, and audio output unit 508. According to another embodiment, the control unit 502 may include the image processing unit 504.

The control unit 502 transmits an image capture message to the camera unit 506 at Step 510. The image capture message may include a command for at least one camera included in the camera unit 506 to capture an image.

The camera unit 506 transmits the captured image to the image processing unit 504 at Step 515.

The image processing unit 504 detects at least one object from the received image at Step 520. In more detail, the image processing unit 504 can identify identical objects by analyzing the outline of the received image. Further, the image processing unit 504 can identify a distance to an object on the basis of the phase difference of an object identified from a plurality of images.

The image processing unit 504 analyzes objects located in a specific range of identified objects at Step 525. In more detail, the specific range can be determined according to the setting mode of the terminal. If a user sets the mode for reading a book, the specific range can be formed in a shorter distance; and if the user is moving out of a door, the specific range can be formed in a longer distance. Further, the operation of analyzing an object may include at least one of character recognition, distance recognition of neighboring object, shape recognition of pre-stored pattern, and face recognition. The pre-stored pattern may include an object having a specific shape such as a building or a traffic sign.

The image processing unit 504 transmits the analyzed object information to the control unit 502 at Step 530.

The control unit 502 determines an output on the basis of the received object information at Step 535. In more detail, if the identified object includes an analyzable text, the control unit 502 can determine to output the text in a voice. Further, the distance to an identified object can be noticed through a voice or a beep sound. The beep sound can give notice to a user by a change of the frequency of the beep sound according to distance. In case of a pre-stored pattern, a voice including the pre-stored pattern information and location information can be determined as an output. In case of face recognition, a voice including personal information corresponding to a pre-stored face can be determined as an output.

The control unit 502 transmits the determined sound output signal to the audio output unit 508 at Step 540.

The audio output unit 508 outputs a sound corresponding to the received sound output signal at Step 545.

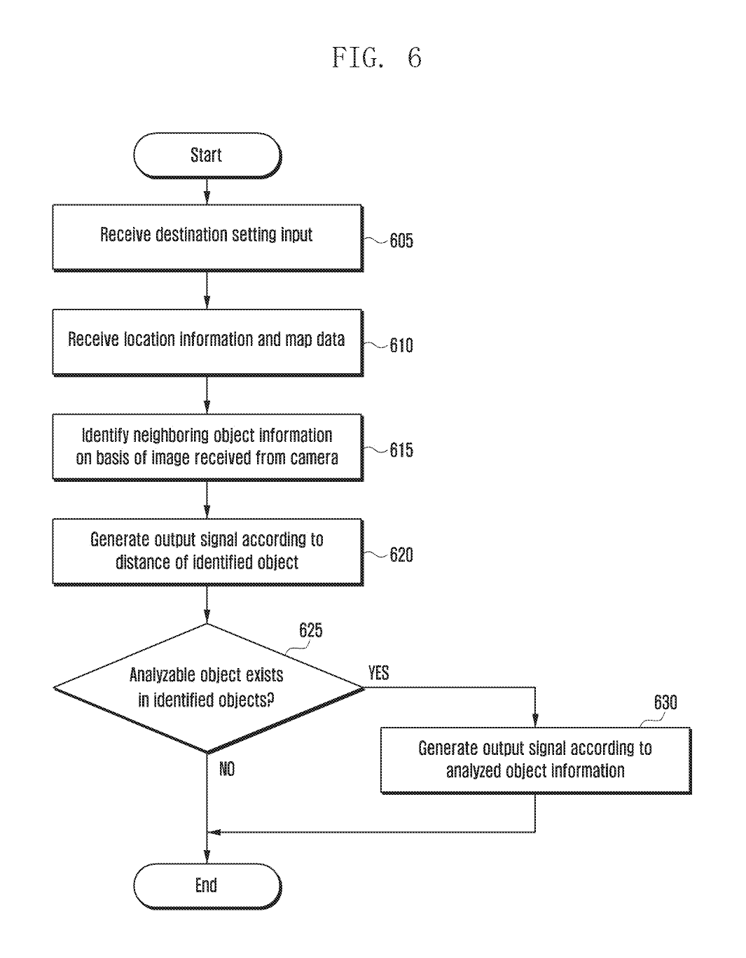

FIG. 6 is a flowchart illustrating a method for identifying a user's location information and outputting related information in a terminal according to an embodiment of the present disclosure.

Referring to FIG. 6, the terminal according to an embodiment of the present disclosure receives a destination setting at Step 605. The destination setting can be input on a map by a user or according to a search input. The search input is performed on the basis of pre-stored map data, and the map data can be stored in the terminal or in a separate server.

The terminal receives at least one of location information of the terminal and the map data at Step 610. The location information can be received from a GPS. The map data may include destination information corresponding to location information and a path to the destination. Further, the map data may include image information of an object located in the path. For example, the map data may include image information of a building located in the path, and the terminal can identify the current location of the terminal by a comparison with image information of the building if an image is received from a camera unit. More detailed operations can be performed through the following steps.

The terminal identifies neighboring object information of an image received from a camera at Step 615. An object located in a specific distance range can be identified according to mode setting. In more detail, the terminal can identify whether an analyzable object exists in the received image, identify a distance to the object, and analyze the identified object. The terminal can identify the current location by using at least one of a distance to a neighboring object, object analysis result, and received map data. Further, the terminal can use location information obtained from a GPS sensor subsidiarily.

The terminal generates an output signal according to the distance to the identified object at Step 620. The output signal may include an audio output warning a user according to at least one of a distance to an object and a moving speed of the object. In more detail, if an identified object approaches a user, a warning can be given to the user through a beep sound so that the user can take action to avoid being hit. Further, when the user moves along a path set by the user according to identified objects, an output signal may not be transmitted or an audio signal confirming a safe movement along the path can be output.

The terminal identifies whether an analyzable object exists in the identified objects at Step 625. In more detail, the analyzable object may include at least one of pattern information stored in the terminal or a separate server, text displayed on an object, and an object corresponding to map information received by the terminal. In this embodiment, the pattern information may include a road sign. The object corresponding to map information can be determined by comparing surrounding geographic features and image information received at Step 615.

If an analyzable object exists, the terminal generates an output signal according to analyzed object information at Step 630. For example, a sound output signal related to the analyzed object information can be generated and transmitted to a user.

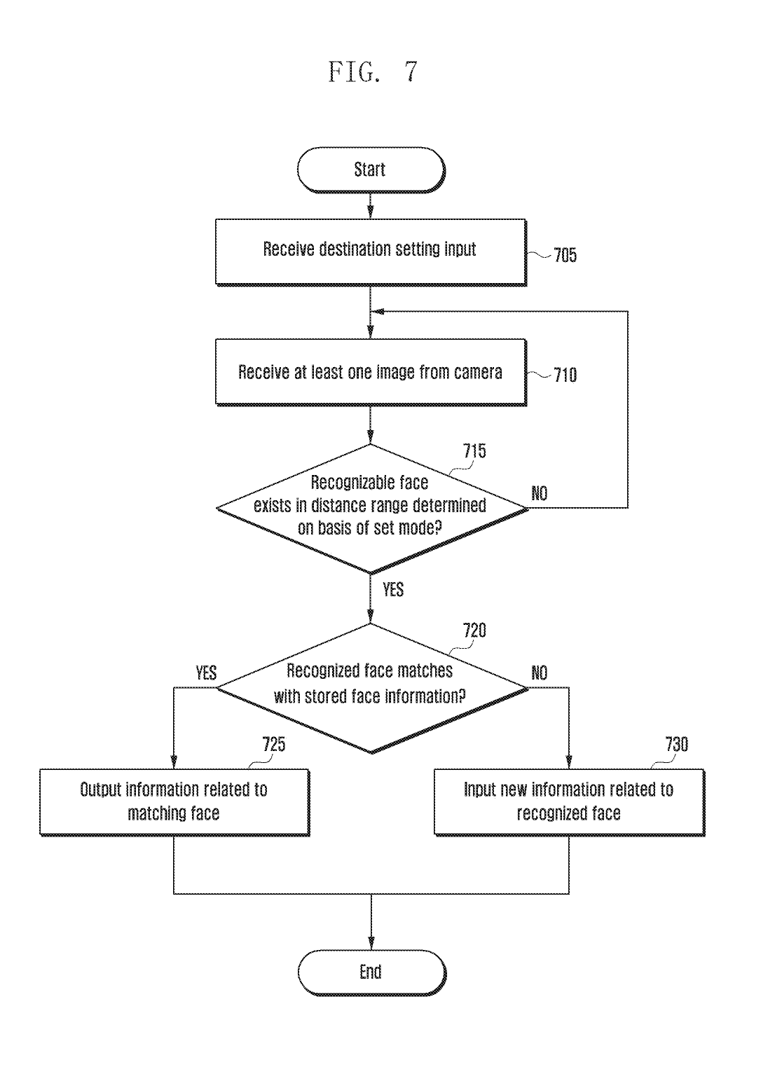

FIG. 7 is a flowchart illustrating a method for recognizing a face and providing related information according to an embodiment of the present disclosure.

The terminal according an embodiment of the present disclosure receives an input for setting a mode at Step 705. In more detail, an object including a face can be identified according to the input for setting a mode, and a distance range for identifying an object including a face can be determined. The mode setting can be determined according to at least one of a user input and a state of using the terminal. If it is identified that the user moves indoors, the mode setting can be changed suitably for face recognition without a separate user input. Further, if another person's face is recognized, the mode setting can be changed suitably for face recognition.

The terminal receives at least one image from a camera at Step 710. The image can be received from a plurality of cameras, and a plurality of images captured by each camera can be received.

The terminal identifies whether a recognizable face exists in a distance range determined according to the mode setting at Step 715. If no recognizable face exists Step 710 can be re-performed, and a signal including information that no recognizable face exists can be output selectively. If a voice other than the user's voice is received, the terminal can perform face recognition preferentially.

If a recognizable face exists, the terminal identifies whether the recognized face is identical to at least one of the stored faces at Step 720. The stored face can be set according to information of images taken by the terminal or stored by receiving from a server.

The terminal outputs information related to a matching face at Step 725. In more detail, sound information related to the recognized face can be output.

The terminal receives new information related to the recognized face at Step 730. The terminal can store the received information in a storage unit.

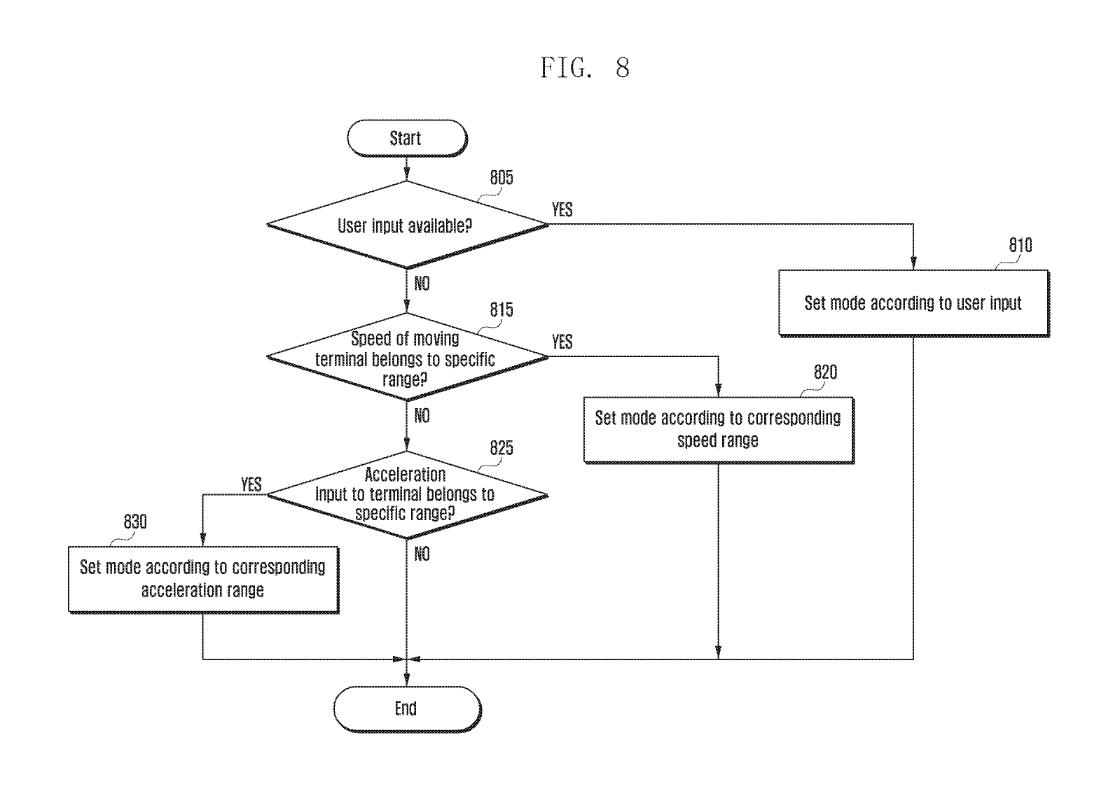

FIG. 8 is a flowchart illustrating a method for setting a mode of a terminal according to an embodiment of the present disclosure.

Referring to FIG. 8, the terminal identifies whether a user input for setting a mode is received at Step 805. The user input may include an input generated by a separate input unit and conventional inputs of a terminal such as a switch input, gesture input, and voice input. Further, the mode according to an embodiment of the present disclosure may include at least one of a reading mode, navigation mode, and face recognition mode; and the terminal can operate by selecting candidates of a recognized distance and a recognized object in order to perform a corresponding function for each mode. Each mode can be performed simultaneously.

If a user input is received, an operation mode of the terminal is determined according to the user input at Step 810.

The terminal identifies whether a movement speed of the terminal is in a specific range at Step 815. In more detail, the terminal can estimate a user's movement speed by using movement distance changes of objects and time captured by a camera. Further, the user's movement speed can be estimated by using a separate sensor such as a GPS sensor. If the movement speed is in a specific range, modes of various steps can be changed, and a time interval of capturing an image can be changed according to the mode change. The movement speed can be preset in the terminal or determined according to an external input so that the terminal can identify a range of movement speeds.

If the identified movement speed is in a specific range, the mode is determined according to a corresponding speed range at Step 820. If the movement speed is greater than a predetermined value, the terminal can identify that the user is moving outdoors and set the mode correspondingly. Further, if the movement speed is identified such that the user is moving by means of a vehicle, a navigation mode can be deactivated or a navigation mode suitable for movement by means of a vehicle can be activated.

The terminal identifies whether an input acceleration is in a specific range at Step 825. In more detail, if the acceleration is identified to be greater than a specific range by measuring the acceleration applied to the terminal through a gyro sensor, the terminal can determine that the terminal or the user is heavily vibrating and set a corresponding mode at Step 830.

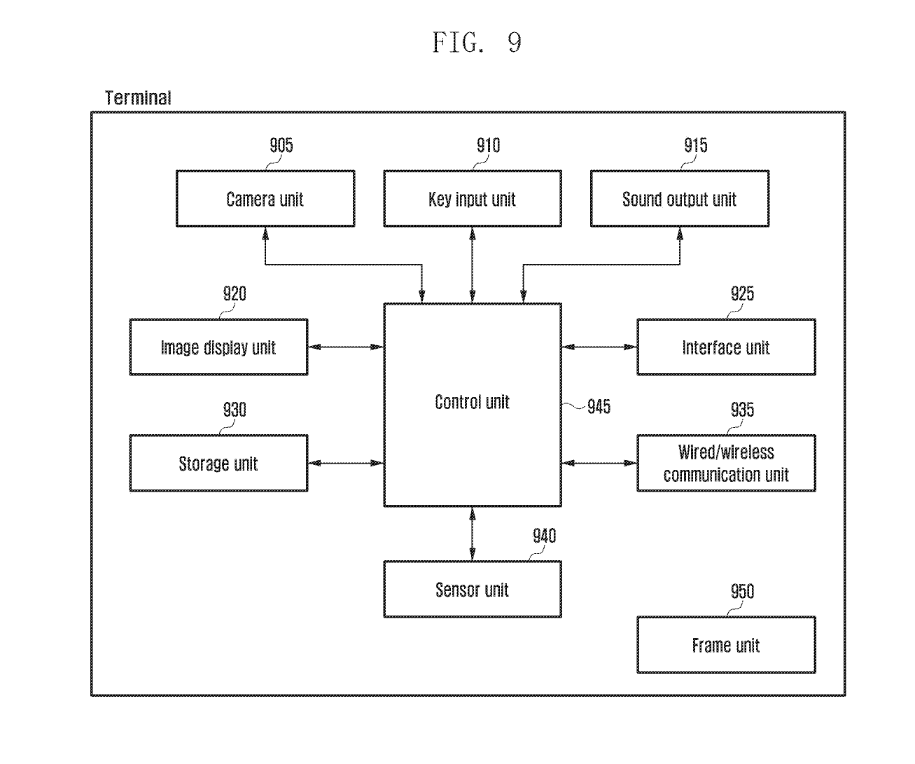

FIG. 9 is a block diagram illustrating components included in a terminal according to an embodiment of the present disclosure.

According to an embodiment of the present disclosure, the terminal may include at least one of a camera unit 905, input unit 910, sound output unit 915, image display unit 920, interface unit 925, storage unit 930, wired/wireless communication unit 935, sensor unit 940, control unit 945, and frame unit 950.

The camera unit 905 may include at least one camera and can be located in a direction corresponding to a user's sight. Further, another camera can be located at a part of the terminal not corresponding to the user's sight and can capture an image located in front of the camera.

The input unit 910 can receive a physical user input. For example, a user's key input or a voice input can be received by the input unit 910.

The sound output unit 915 can output information related to operations of the terminal in an audio form. In more detail, the terminal can output a voice related to a recognized object or a beep sound corresponding to a distance to an object recognized by the terminal.

The image display unit 920 can output information related to operations of the terminal in a visual output form by using a light emitting device such as an LED or a display device which can output an image. Further, a display device in a projector form can be used to include an image in the user's sight.

The interface unit 925 can transmit and receive a control signal and an electric power by connecting the terminal to an external device.

The storage unit 930 can store information related to operations of the terminal. For example, the storage unit 930 can include at least one of map data, face recognition data, and pattern information corresponding to images.

The wired/wireless communication 935 may include a communication device for communicating with another terminal or communication equipment.

The sensor unit 940 may include at least one of a GPS sensor for identifying a location of the terminal, movement recognition sensor, acceleration sensor, gyro sensor, and proximity sensor, and the sensor unit 940 can identify an environment in which the terminal is located.

The control unit 945 can control other components of the terminal to perform a specific function, identify an object through image processing, measure a distance to the object, and transmit an output signal to the sound output unit 915 and the image display unit 920 according to the result of identifying an object.

The frame unit 950 may be formed in an eyeglasses shape according to an embodiment of the present disclosure so that a user can wear the terminal. However, the shape of the frame unit 950 is not limited to the eyeglasses shape and can have another shape like a cap.

Further, general operations of the terminal can be controlled by the control unit 945.

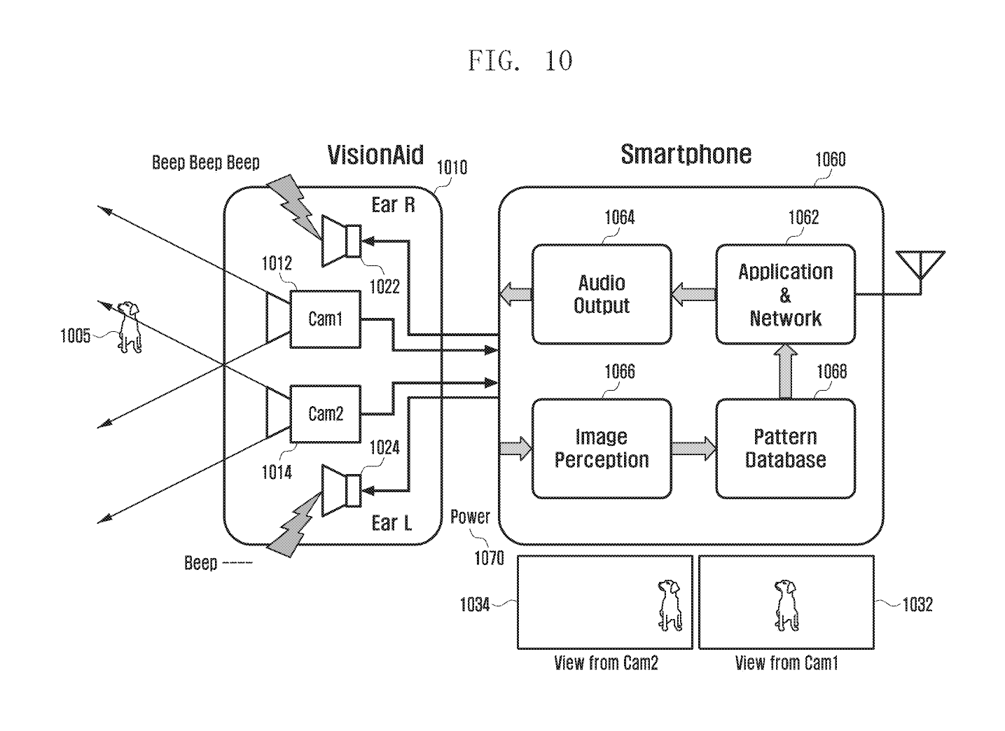

FIG. 10 is a schematic drawing illustrating components of a terminal according to another embodiment of the present disclosure.

Referring to FIG. 10, the terminal 1010 according to an embodiment of the present disclosure can identify an object 1005. The terminal 1010 may include a first camera 1012 and a second camera 1014. The terminal 100 may further include a first audio output unit 1022 and a second audio output unit 1024. The terminal 1010 can be connected to an external device 1060 (for example, smartphone) through an interface unit.

The terminal 1010 can transmit an image including an object 1005 to the external device 1060 by capturing the image through the first camera 1012 and the second camera 1014. In this embodiment, a first image 1032 and a second image 1034 are images captured respectively by the first camera 1012 and the second camera 1014.

The external device 1060 which received an image can identify a distance to the object 1005 by using an image perception 1066, pattern database 1068, and application and network unit 1062 and transmit an audio output signal to the terminal 1010 through an audio output unit 1064. The terminal 1010 can output an audio signal through the first audio output unit 1022 and the second audio output unit 1024 on the basis of the audio output signal received from the external device 1060. In this embodiment, the object 1005 is located closer to the first camera 1012; thus, a beep sound in a higher frequency can be output by the first audio output unit.

In this embodiment, the external device is configured to supply an electric power 1070 to the terminal 1010; however, a power supply module can be included in the terminal 1010 itself as another embodiment.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method for controlling a terminal comprising a camera, the method comprising:
receiving an image through the camera;
identifying at least one object from the received image;
calculating a distance between the object and the terminal based on information related to the identified object; and
outputting a signal identified based on the distance between the calculated object and the terminal.

2. The method of claim 1, wherein receiving an image comprises receiving each image captured by a plurality of cameras, and
calculating a distance between the object and the terminal comprises calculating a distance between the object and the terminal based on differences between the distances of the plurality of cameras and differences of the object locations displayed in the each image.

3. The method of claim 1, further comprising:
receiving information related to a distance; and
analyzing an object located in a distance range identified according to distance information between the identified object and the terminal.

4. The method of claim 1, further comprising:
analyzing the identified object,
wherein the analysis is performed for the identified object by using at least one of character recognition, face recognition, and pattern recognition.

5. The method of claim 4, wherein performing face recognition based on the extracted object further comprises:
comparing face information recognized from the object with information stored in the terminal;
outputting matching information and related signals if information matching with the comparison result exists; and
receiving information related to the recognized face information if information matching with the comparison result does not exist.

6. The method of claim 1, wherein outputting a signal comprises outputting an audio signal to an audio output unit selected based on a distance between the terminal and an object calculated from a plurality of audio output units of the terminal.

7. The method of claim 1, further comprising:
receiving location information of a destination and location information of the terminal,
wherein outputting a signal comprises outputting an audio signal identified based on the location information of the destination, location information of the terminal, and a distance between the terminal and an object calculated by the terminal.

8. A terminal for receiving an image input, the terminal comprising:
a camera unit configured to receive an image input; and
a control unit configured to control the camera unit, to receive an image from the camera unit, to determine at least one object from the received image, to calculate a distance between the object and the terminal based on information related to the identified object, and to output a signal identified based on the distance between the calculated object and the terminal.

9. The terminal of claim 8, wherein the control unit receives each image captured by a plurality of cameras, and calculates a distance between the object and the terminal based on distances between the plurality of cameras and differences of location information of the objects displayed in the each image.

10. The terminal of claim 8, wherein the control unit receives information related to a distance, and analyzes an object located in a distance range identified according to distance information between the identified object and the terminal.

11. The terminal of claim 8, wherein the control unit analyzes the identified object, and the analysis is performed for the identified object by using at least one of character recognition, face recognition, and pattern recognition.

12. The terminal of claim 8, wherein the control unit compares face information recognized from the object with information stored in the terminal, outputs matching information and related signals if information matching with the comparison result exists, and receives information related to the recognized face information if information matching with the comparison result does not exist.

13. The terminal of claim 8, wherein the control unit outputs an audio signal to an audio output unit selected based on a distance between the terminal and an object calculated from a plurality of audio output units of the terminal.

14. The terminal of claim 8, wherein the control unit receives location information of a destination and location information of the terminal, and outputs an audio signal identified based on the location information of the destination, location information of the terminal, and a distance between the terminal and an object calculated by the terminal.
